(19) United States
(12) Patent Application Publication
(10) Pub. No.: US 2004/0205538 A1
(43) Pub. Date: Oct. 14, 2004

(54) Method and apparatus for online integration of offline document correction

(75) Inventors: Dwip N. Banerjee, Austin, TX (US); Rabindranath Dutta, Austin, TX (US)

Correspondence Address: STREETS & STEELE, 13831 NORTHWEST FREEWAY, SUITE 355, HOUSTON, TX, 77040, US

(73) Assignee: INTERNATIONAL BUSINESS MACHINES CORPORATION, Armonk, NY (US)

(21) Appl. No.: 09/826,750

(22) Filed: Apr. 5, 2001

(51) Int. Cl. G06F 15/00

(52) U.S. Cl. 715/511; 715/530

(57) ABSTRACT

A method for making indirect corrections or modifications to online documents by generating an offline document, the corrections are inscribed onto the offline document, then the corrected offline document is scanned into the computer to form an online version of the offline document. Software instructions or code are then executed to translate the online version of the offline document into an online document containing the corrections. In a preferred embodiment, the offline document is generated from an online document and the online version of the offline document is integrated or compared with the online document.

### BACKGROUND OF THE INVENTION

1. Field of the Invention

The present invention relates to methods for editing text in word processing software files.

2. Description of the Related Art

The proliferation of computers in our lives has brought about a number of changes in how work gets done. In particular, computers with word processing software have increased the productivity of document production. Instead of retyping an entire document whenever changes are made, the flexibility of using word processors allows the user to edit only those portions of the document that are to be added, deleted, or otherwise changed. This is an extremely powerful advantage over mere typing, because the edited portion of a document is typically very minor in comparison with the whole document.

However, there is still a portion of the workforce that is more comfortable dealing with paper documents, otherwise referred to as “hard copies” or “offline documents.” It may be that those people preferring to edit offline documents are not trained on computers or the word processing software. Alternatively, the offline document may be easier to carry or use in remote locations in the absence of a notebook computer. Still, it may be human factors, such as eye strain, repetitive stress injuries or sitting position, that lead people to prefer editing offline documents over their online counterparts.

Regardless of the reason for offline editing, the physical effort that goes into the manual editing is substantially wasted, because it is still necessary for someone to enter the additions, deletions and other modifications into the online document.

Furthermore, the additional step of entering the modifications into the online document presents a further opportunity for human error or mistake, thereby necessitating a subsequent review of an updated offline document and potentially more editing.

Therefore, it should be apparent that the full productivity gain to be realized through the use of word processing software is thus potentially compromised by the necessity to enter manual changes made to an offline version of an online document. Therefore, there is a need for a system and method that accommodates editing of offline documents without the attendant productivity loss of requiring a second person to enter the manually written changes into word processing software. More particularly, there is a need to utilize the manually written or inscribed changes in a more efficient manner and avoid duplicating efforts. It would be desirable if the system and method utilized existing and common office technology and equipment.

### SUMMARY OF THE INVENTION

The present invention relates to a method for making corrections to online documents. However, instead of making the corrections directly to the online document, the present invention allows for indirectly correcting the online document. Accordingly, an offline document is printed from the online document, the corrections or modifications are inscribed onto the offline document, and then the corrected offline document is scanned into the computer to form an online version of the offline document. Software instructions or code are then executed to translate the online version of the offline document into a subsequent online document containing the corrections.

The present invention provides a method comprising identifying images, such as the the location and content of corrections, in an online version of an offline document that are not in an online document that is the original electronic file version of the document, wherein the images include a combination of one or more new text segments and one or more editing instructions. A subsequent version of the online document is generated by executing each of the one or more editing instructions at the identified location of each instruction and inserting each of the one or more text segments at the identified location of each text segment. Preferably, the one or more editing instructions are selected from the group consisting of delete, insert, move, capitalize, change font, subscript, superscript and combinations thereof, and the one or more text segments are selected from the group consisting of alphabetic characters, numbers, symbols, words, sentences, paragraphs, and combinations thereof. Optionally, the location of the images that comprise the corrections is identified by performing a character-by-character comparison of the online version of the offline document with the online document. Anchor points may be set in the online document at the locations of the identified images and the content of the images or corrections may be associated with the respective anchor points. Preferably, the method includes identifying the one or more editing instructions from a predetermined set of editing symbols. The subsequent version of the online document is suitably provided in a redline format.

In an alternative embodiment, the method of the present invention comprises interpreting a first text image to identify and locate one or more text segments and one or more instructions selected from a predetermined set of text editing symbols, and executing the one or more instructions at the identified locations to modify the one or more text segments. The method may also comprise scanning an offline document that has been marked or inscribed with one or more corrections or modifications to create the first text image. Furthermore, the method may comprise preparing a subsequent online document, with the same or different filename, incorporating the one or more text segments as modified by the one or more instructions.

The foregoing and other objects, features and advantages of the invention will be apparent from the following more particular description of a preferred embodiment of the invention, as illustrated in the accompanying drawings wherein like reference numerals represent like parts of the invention.

### BRIEF DESCRIPTION OF THE DRAWINGS

FIG. 1 illustrates preferred system architecture for a computer system suitable for carrying out the present invention.

FIG. 2 is a flowchart illustrating the evolution of the documents involved in the present invention.

FIG. 3 is a flowchart illustrating a preferred embodiment of the present invention for integrating an edited version of an offline document into an online document.

FIG. 4 is a table of standard editing symbols that may be utilized in accordance with the invention.

### DETAILED DESCRIPTION

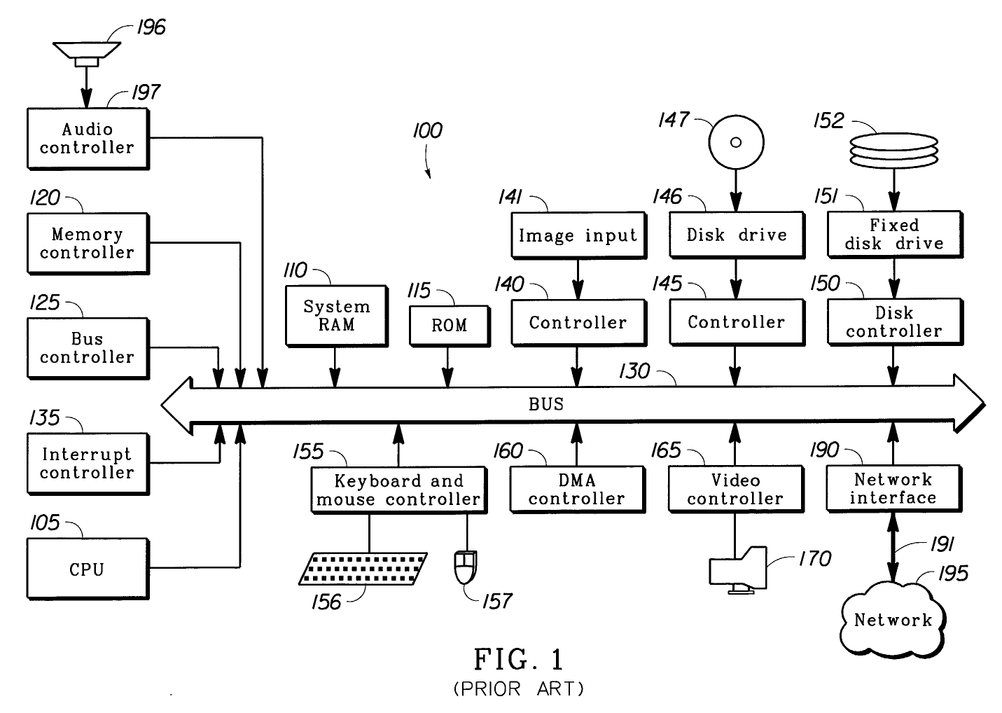

FIG. 1 illustrates an exemplary system architecture for a computer system 100 such as an IBM PS/2®, on which the invention may be implemented. The exemplary computer system of FIG. 1 is for descriptive purposes only. Although the description may refer to terms commonly used in describing particular computer systems, such as in IBM PS/2® computer, the description and concepts equally apply to other systems, including systems having architectures dissimilar to FIG. 1.

Computer system 100 includes a central processing unit (CPU) 105, which may be implemented with a conventional microprocessor, a random access memory (RAM) 110 for temporary storage of information, and a read only memory (ROM) 115 for permanent storage of information. A memory controller 120 is provided for controlling RAM 110.

A bus 130 interconnects the components of computer system 100. A bus controller 125 is provided for controlling bus 130. An interrupt controller 135 is used for receiving and processing various interrupt signals from the system components.

Mass storage of data may be provided by diskette 142, CD ROM 147, or hard drive 152. Data and software may be exchanged with computer system 100 via removable media 147 such as diskette of CD ROM. Removable media 147 is insertable into drive 146 that is, in turn, connected to bus 130 by a controller 145. Hard disk 152 is part of a fixed disk drive 151 that is connected to bus 130 by controller 150.

User input to computer system 100 may be provided by a number of devices. For example, a keyboard 156 and mouse 157 are connected to bus 130 by controller 155.

Similarly, an image input device 141, such as a scanner, is connected to bus 130 by controller 140. An optional audio transducer 196, which may act as both a microphone and a speaker, is connected to bus 130 by audio controller 197, as illustrated. It will be obvious to those skilled in the art that other input devices, such as a pen and/or tabloid may be connected to bus 130 and an appropriate controller and software, as required. DMA controller 160 is provided for performing direct memory access to RAM 110. A visual display is generated by video controller 165 that controls video display 170. Computer system 100 also includes a communications adaptor 190 that allows the system to be interconnected to a local area network (LAN) or a wide area network (WAN), schematically illustrated by bus 191 and network 195.

Operation of computer system 100 is generally controlled and coordinated by operating system software, such as the OS/2® operating system, available from International Business Machines Corporation, Boca Raton, Fla. or Windows 95® from Microsoft Corp., Edmond, Wash. The operating system controls allocation of system resources and performs tasks such as processing scheduling, memory management, networking, and I/O services, among things. In particular, an operating system 210 resident in system memory and running on CPU 105 coordinates the operation of the other elements of computer system 100. The present invention may be implemented with any number of commercially available operating systems including OS/2, UNIX Windows NT and DOS, etc. One or more applications 202 such as Lotus Notes, commercially available from Lotus Development Corp., Cambridge, Mass., may be, executable under the direction of operating system 215. If operating system 215 is a true multitasking operating system, such as OS/2, multiple applications may execute simultaneously.

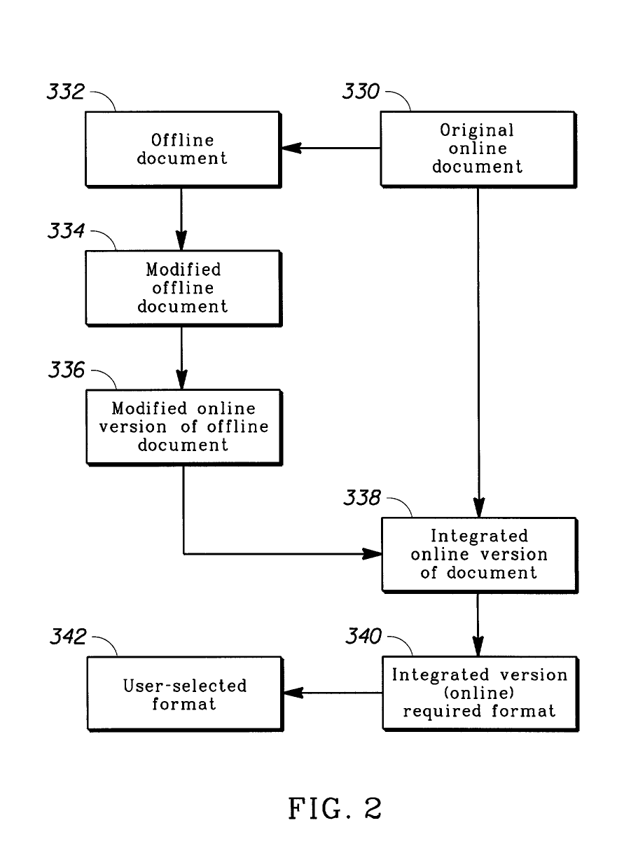

FIG. 2 is a flowchart illustrating the evolution of the documents involved in the present invention. An online document 330 is used to generate an offline document 332. The offline document 332 is edited to produce a corrected or modified offline document 334. The modified offline document 334 is then processed by an image input device to produce a modified online version of the offline document 336. The online version of the offline document 336 is then integrated with the original online document 330 to form an integrated online version of the document 338. Finally, the integrated online version of the document 338 is prepared into a subsequent online document 340 having a format as determined by a user-selected format 342.

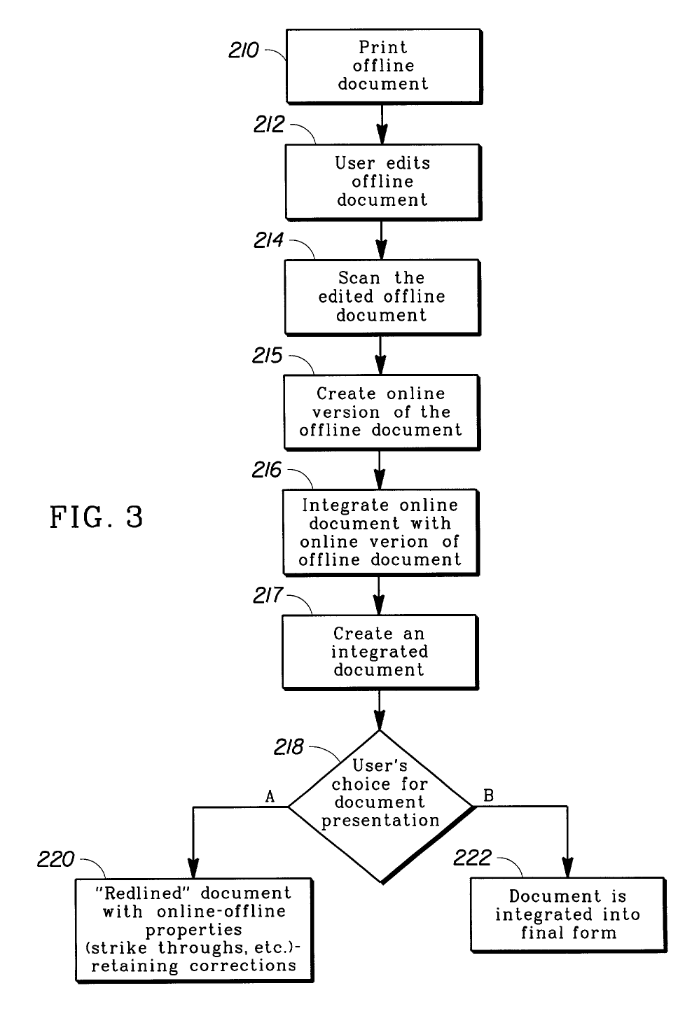

FIG. 3 is a flowchart illustrating a preferred embodiment of the present invention for integrating an edited version of an offline document into an online document. A representation of the online document is printed to form an offline document in step 210. The offline document is then edited or corrected by one or more individuals by inscribing or otherwise affixing corrections or modifications directly onto the offline document in step 212. The edited offline document is processed through an image input device, preferably a scanner, in step 214. Consequently, an online version, such as a bit map image, of the offline document is created in step 215. The system 100 uses manual or automatic Optical Character Recognition (“OCR”) methods to interpret the text and other characters, images and objects in the online version of the offline document. The software and methods used to implement Optical Character Recognition (“OCR”) of a scanned bit map image are generally publicly known and commercially available. Therefore, a detailed description of OCR processes is not described herein. However, it is preferred that the OCR process provide a text interpretation of the bit map image, although set interpretations or non-text sequence interpretations may also form part of the online version of the offline document.

The online version of the offline document is integrated or compared with the online document in step 216. In step 217, an integrated document is created that contains the online document as well as the text and other characters, images or objects that comprise the corrections. In performing this integration, the system may use various superimposition techniques, anchor point matching, scaling and the like, as well as the execution of any instructions interpreted from the online version of the offline document. For example, the modified text or instructions that identified in the online version of the offline document can be matched up with anchor points set within the online document at the points where the modified text or instructions are to be effectuated. While the OCR system may be helpful or necessary for a character-by-character or line-by-line comparison of the two files, the critical role of the OCR system in accordance with the present invention is to recognize the text and instructions that have been added to the online version of the offline document by virtue of the inscribed markups on the offline document. Therefore, the OCR system should be provided with the standard editing symbols or otherwise programmed to recognize the images identified.

After preparing the integrated online document, an optional feature of the invention is to allow the user to select a document representation in step 218. For example, choice A will produce a “red-lined” document that retains all of the combined information of the online document and the online version of the offline document by distinguishing the inserted and deleted characters in a unique fashion, such as underlining (for inserted characters) and strike-throughs (for deleted characters), in step 220. Choice B will produce a “final form” of the document with all tracking of corrections removed and there is no longer any information about the nature of the corrections that were made, in step 222. Preferably, the corrected online document will be a “red-lined version” or in “track changes format” in the sense that all the corrections are made, but both the current and previous conditions of the document are viewable such as by underlining insertions and striking-through deletions. This format is preferable because the user can approve or disapprove of the changes made by the present method or system. Other formats for storing and displaying the corrected online document will be apparent to those in the art and these formats are considered to be within the scope of the invention.

The term “online document”, as used herein, shall mean any digital file containing information that is representative of, displayable as, or having resemblance to a document. Specific examples of online documents include word processing files, notepad files, ASCII files and the like. The term “offline document”, as used herein, shall mean a document that is a physical representation of the digital file. Specific examples of offline documents include file printouts, faxes, screen shots, visual displays (such as monitors and personal data assistant screens), e-books and the like. The term “text segment”, as used herein, shall mean an identified portion of alphanumeric content, such as words, numbers, symbols, sentences and paragraphs. Finally, the term “corrections”, as used herein, shall mean any changes made to a document or instructions for making changes to a document. Specific examples of corrections or modifications include, but are not limited to, deletions, insertions, move text, copy text, capitalization, changing font, subscripting and superscripting. Other typical corrections might include any of the common features of word processing software.

An “image input device” is a device that can receive an image and provide a signal defining a version of the image. A “scanner” is an image impute device that receives an image by a scanning operation, such as by scanning the document. A “user input device” is a device such as a keyboard or a mouse that can provide signals based on actions of a user. An “image output device” is a device that can provide an image as output. A “display” is an image output device that provides information in visual form, such as on the screen of a cathode ray tube. A “character” means a discrete element that appears in a writing system. Characters in the English language can include not only alphabetic and numerical elements, but also punctuation marks, diacritical marks, mathematical and logical symbols, and other elements used in writing English. A “word” is a set of one or more characters that is treated as a semantic unit in a given language

In accordance with an alternative embodiment, an online document is created from an corrected offline document without accessing or making comparison to the original online document, but relying solely on the online version of the offline document. This may prove to be of particular advantage when the online document is at another location or has been deleted, or perhaps even allowing the editing of documents from other sources altogether where the online document is not accessible, such as an excerpt of a magazine article. However, this alternative embodiment requires processing the entire offline document from the scanned bit map file into a text file. While great improvements in OCR processing have been realized in recent years, this process is memory intensive and may introduce errors into the online document that did not previously exist.

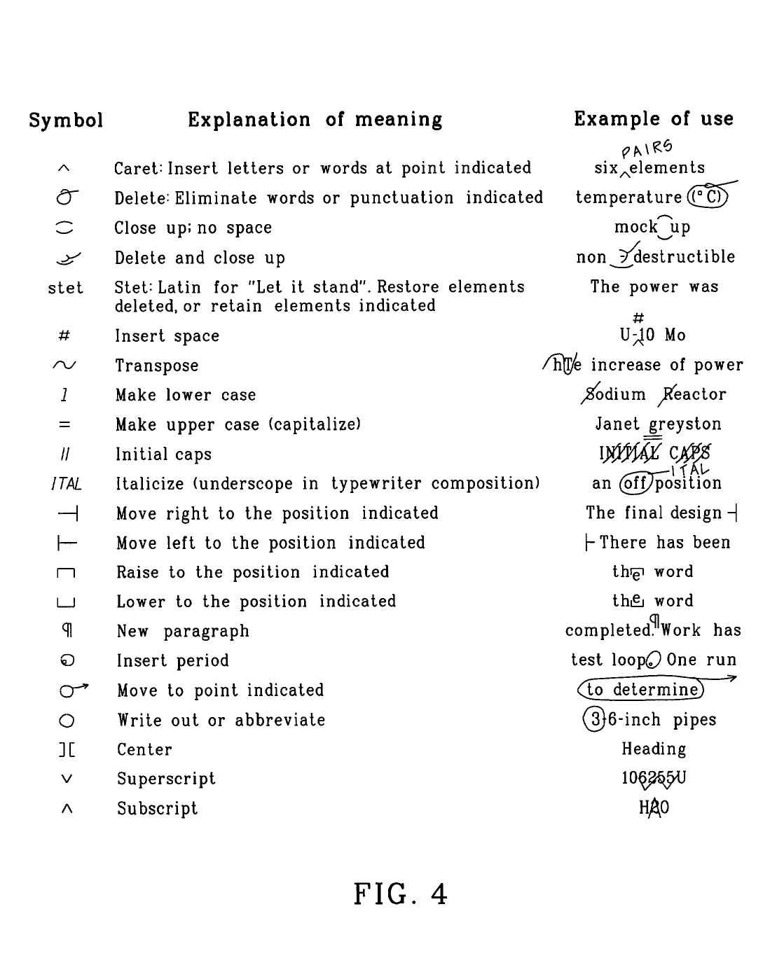

FIG. 4 is a partial listing of standard editing symbols that may be utilized in accordance with the invention. While the format of the corrections or instructions to make corrections may take many forms, it is preferred for the instructions to follow, or at least be consistent with, standard proofreading or editing symbols that can be found in publicly available style guides, such as those illustrated in FIG. 4. For example, the writing of a “¶” symbol means to start a new paragraph, the writing of a “#” symbol means to insert a space, and the like. Alternatively, the software might include its own set of editing symbols that are recognizable to optical character recognition software. Still further, the system may include the capability to “learn” new or shortcut symbols that are individually customizable or that are able to trigger more advanced functions of the word processing software, for example a “ΔPS 1” to mean “change to paragraph style 1” which, of course, would have to be predefined in the word processing software.

It will be understood from the foregoing description that various modifications and changes may be made in the preferred embodiment of the present invention without departing from its true spirit. It is intended that this description be for purposes of illustration only and should not be construed in a limiting sense. The scope of this invention should be limited only by the language of the following claims.

What is claimed is:

1. A method comprising:
identifying images in an online version of an offline document that are not in an online document that was used to produce the offline document, wherein the images include a combination of one or more text segments and one or more editing instructions; and
generating a subsequent version of the online document by executing each of the one or more editing instructions and inserting each of the one or more text segments.

2. The method of claim 1, wherein the one or more editing instructions are selected from the group consisting of delete, insert, move, capitalize, change font, subscript, superscript, and combinations thereof.

3. The method of claim 1, wherein the one or more text segments are selected from the group consisting of alphabetic characters, numbers, symbols, words, sentences, paragraphs, and combinations thereof.

4. The method of claim 1, further comprising identifying the location of the images by performing a character-by-character comparison of the online version of the offline document with the online document.

5. The method of claim 4, further comprising setting anchor points in the online document at the locations of the images.

6. The method of claim 5, further comprising associating the images with the respective anchor points.

7. The method of claim 6, further comprising storing the subsequent version of the online document in a redline format.

8. The method of claim 1, further comprising identifying the one or more editing instructions from a predetermined set of editing symbols.

9. A method comprising:
interpreting an online version of a first text image to identify and locate one or more text segments and one or more editing instructions selected from a predetermined set of editing symbols; and
executing the one or more editing instructions at the identified locations to modify the one or more text segments.

10. The method of claim 9, further comprising:
creating the first text image by scanning an offline document that has been marked with the one or more editing instructions.

11. The method of claim 10, further comprising:
preparing an online document incorporating the one or more text segments as modified by the one or more instructions.

12. The method of claim 10, further comprising:
generating the offline document by printing an online document.

13. A method comprising:
identifying inscribed images in an online version of an offline document that are not in an online document that was used to produce the offline document, wherein the inscribed images include a combination of one or more text segments and one or more editing instructions; and
generating a subsequent version of the online document by executing each of the one or more editing instructions and inserting each of the one or more text segments.

14. A method comprising:
printing an online document to generate an offline document;
inscribing the offline document with one or more editing instructions selected from a predetermined set of editing symbols;
scanning the inscribed offline document to create an online version of the inscribed offline document;
identifying and locating the one or more editing instructions in the online version of the inscribed offline document;
executing the one or more editing instructions at the identified locations to form a subsequent online document.

15. A system for producing documents comprising:
a processor;
a memory coupled to the processor;
a computer readable medium coupled to the processor containing instructions for:
identifying images in an online version of an offline document that are not in an online document that was used to produce the offline document, wherein the images include a combination of one or more text segments and one or more editing instructions; and
generating a subsequent version of the online document, by executing each of the one or more editing instructions and inserting each of the one or more text segments.

16. The system of claim 15, wherein the one or more editing instructions are selected from the group consisting of delete, insert, move, capitalize, change font, subscript, superscript, and combinations thereof.

17. The system of claim 15, wherein the one or more text segments are selected from the group consisting of alphabetic characters, numbers, symbols, words, sentences, paragraphs, and combinations thereof.

18. The system of claim 15, further comprising:
instructions for identifying the location of the images including comparing means for performing a character-by-character comparison of the online version of the offline document with the online document.

19. The system of claim 18, further comprising instructions for setting anchor points in the online document at the locations of the identified images.

20. The system of claim 19, further comprising instructions for associating the images with the respective anchor points.

21. The system of claim 20, further comprising instructions for storing the subsequent version of the online document in a redline format.

22. The system of claim 15, further comprising instructions for identifying the one or more editing instructions from a predetermined set of editing symbols.

23. A computer readable medium containing executable program instructions for performing a method comprising:
identifying images in an online version of an offline document that are not in an online document that was used to produce the offline document, wherein the images include a combination of one or more text segments and one or more editing instructions; and
generating a subsequent version of the online document, by executing each of the one or more editing instructions and inserting each of the one or more text segments.

24. The computer readable medium of claim 23, wherein the one or more editing instructions are selected from the group consisting of delete, insert, move, capitalize, change font, subscript, superscript, and combinations thereof.

25. The computer readable medium of claim 23, wherein the one or more text segments are selected from the group consisting of alphabetic characters, numbers, symbols, words, sentences, paragraphs, and combinations thereof.

26. The computer readable medium of claim 23, further comprising identifying the location of the images, by performing a character-by-character comparison of the online version of the offline document with the online document.

27. The computer readable medium of claim 26, further comprising setting anchor points in the online document at the locations of the identified images.

28. The computer readable medium of claim 27, further comprising associating the images with the respective anchor points.

29. The computer readable medium of claim 28, further comprising storing the subsequent version of the online document in a redline format.

30. The computer readable medium of claim 23, further comprising identifying the one or more editing instructions from a predetermined set of editing symbols.
